(19) United States
(12) Patent Application Publication
(10) Pub. No.: US 2026/0334464 A1
(43) Pub. Date: Oct. 29, 2026

(54) INCREASED PALATABILITY OF INSECTICIDAL INSECT BAITS

(71) Applicant: BIO LOGIC CROP SCIENCE S.L., Valencia (ES)

(72) Inventor: Victor CASAÑA GINER, Valencia (ES)

(21) Appl. No.: 19/487,264

(22) PCT Filed: May 23, 2024
(86) PCT No.: PCT/EP2024/064316

§ 371 Date: Nov. 24, 2025

(30) Foreign Application Priority Data
May 25, 2023 (ES) ES P202330416

(51) Int. Cl. A01N 25/00; A01N 25/04; A01N 43/50; A01N 53/00; A01P 7/04

(52) U.S. Cl. CPC A01N 25/006; A01N 25/04; A01N 43/50; A01N 53/00; A01P 7/04

(57) ABSTRACT

The present invention discloses compounds that increase the intake of insecticidal insect baits and the insecticidal efficacy of insecticidal baits.

The present application claims priority of PCT/EP2024/064316, filed on May 23, 2024, which claims benefit from Spanish Application No. P202330416, filed on May 25, 2023 and entitled “INCREASED PALATABILITY OF INSECTICIDAL INSECT BAITS”, the disclosure of which being hereby incorporated by reference in its entirety.

### FIELD OF INVENTION

The use of insecticidal baits is a common pest control technique in agriculture, animal husbandry and veterinary medicine, as well as in households and urban areas.

One of the constant problems is the search for new ways of action, reducing the environmental load of insecticides and substituting them with natural or nature-like compounds that have an acceptable or better environmental, toxicological and ecotoxicological profile than the existing ones.

One known technique is to place a food bait and an effective quantity of insecticide in a trap or container containing the bait, so that when the insect eats, it is intoxicated and dies, either immediately (within minutes) or within hours or days (when the effect is intended to be delayed, especially useful in baits for ants that pass the ingested bait to other ants by tropholaxy).

There is a need to reduce the amount of toxic and ecotoxic compounds used for pest control and this is one of the problems to be solved by the present invention. Similarly, improving the efficacy of insecticidal baits is an ongoing problem.

The more an insect ingests of a bait, the greater the amount of insecticide product that affects it, thus maximising the insecticidal effect without having to use high concentrations of insecticide in the baits.

The solution proposed in the present invention consists of adding to usual baits that carry a usual insecticide, or any others that may be used, certain compounds that increase the palatability of the bait, and therefore the ingestion of the same bait and insecticide, so that the death of the target insects is achieved at reduced doses of insecticide.

Some baits are supplemented with proteins, with a supposed increase in palatability, but to date there is no known increase in palatability with a specific amino acid, in a free state, without forming part of any protein, as is the case of serine in the present invention and even of a cyclic isomer of serine itself (cycloserine, in any ratio of D and L isomers, whose activity we have observed to be the same).

The compounds that have been shown to increase the palatability of baits in accordance with the present invention are serine, cycloserine and phloxine B, as well as the synergistic combination of these compounds.

The concentrations at which an increase in palatability is observed range from 0.02% with respect to the total weight of the bait to concentrations greater than 1%. However, for simplicity and economy, it is preferable but not necessary to limit the concentration of serine (CAS No. 302-84-1), cycloserine (CAS No. 68-39-3, provided for example by Sigma-Aldrich with catalogue No. C7005) or phloxine B (CAS No. 18472-87-2) to equal or less than 1%, in particular because there may be solubility problems in such baits.

For use against ants, termites, wasps, flies, mosquitoes, crickets, or cockroaches, the compounds serine, cycloserine and/or phloxine B are preferably used in an insecticide-containing bait composition.

According to ES2347806T3 (Von Deyn et al., BASF, 2010) the compounds serine, cycloserine and/or phloxine B can be used in the baits described in the said Spanish patent.

The bait can be a liquid, solid or semi-solid preparation (e.g. a gel). The solid baits can be formed in various shapes and forms suitable for the respective application e.g. granules, blocks, rods, discs. Liquid baits can be loaded into various devices to ensure proper application, e.g. open containers, aerosol devices, drip fountains, or evaporation fountains. Gels can be based on aqueous or oily matrices and can be formulated for particular needs in terms of tackiness, moisture retention or ageing characteristics.

The bait used in the composition is a product that is sufficiently attractive to entice insects such as ants, termites, wasps, flies, mosquitoes, crickets etc. or cockroaches to eat. Attractiveness can be manipulated by using feeding stimulants or sex pheromones. Feeding stimulants are chosen, for example, but not exclusively, from proteins of animal and/or vegetable origin (meat, fish or blood meal, insect parts, egg yolk), from fats and oils of animal and/or vegetable origin or mono-, oligo- or poly-organo carbides, especially from sucrose, lactose, fructose, dextrose, glucose, starch, pectin or even molasses or honey. Fresh or decaying parts of fruits, crops, plants, animals, insects or specific parts thereof can also serve as a feeding stimulant. Sex pheromones are known to be more specific to insects. Specific pheromones are described in the literature and are known to those skilled in the art. However, there are no known strong attractant pheromones for ants or cockroaches.

### Methodology in the Tests:

Ants: The tests are conducted in transparent plastic boxes covered on top with a mixture of ethanol and talcum powder (talcol) which prevents ants from fleeing. A drop of bait is placed on a holder, and the holder is placed with 10-30 ants and the behaviour of the ants is observed.

The number of ants eating bait is counted every minute until 10′ and every 5 minutes until 30′. The boxes with ants are kept with the sample, with a source of humidity and alternative food to observe mortality at 24 hours and 48 hours.

Cockroaches: The cockroach test protocol, which can be performed at any location with usual temperature and humidity conditions and with field- or insectary-raised cockroaches, consists of collecting cockroaches that are deprived of food for 7 days; on the day of the test, 4 females and 4 males (or the desired number, for individual measurements, only one individual) are placed in boxes in which the bait is placed in a known quantity and the number of visits to the bait is counted every certain time, optionally the quantity ingested every hour or certain minutes is determined by differential weighing. In examples where mortality is considered, the number of individuals turned over per hour (or other defined time) is observed. The bait is removed and replaced with a standard bait-such as pelleted dog food and a water source, such as moistened cotton wool- and daily mortality is monitored for one week.

Flies: Bait is added at 10% in water used by the flies for drinking, placed in 10×10×10 cm³ ordinary breeding nets, ad libitum.

Mosquitoes: Bait is added at 10% in water used by mosquitoes for drinking, placed in ordinary breeding nets, 10×10×10 cm³, ad libitum.

For all insects mentioned above, adult stage insects have been treated.

### EXAMPLE 1

This example shows food baits whose ingestion is increased by the fact that they contain selected components. That is, the effect of increasing palatability in itself is per se a desirable effect, which may be necessary to combine with an insecticide, or to increase the intake of a bait for reasons that may not be extermination or insecticidal (e.g. for the study of metabolites in insects of products ingested as bait, whether radioactively labelled or not).

It should be noted that it is extremely difficult to measure the weight of bait ingested by 10 to 30 ants in the reasonable 45-minute test period. On the one hand, baits can acquire water from the environment, or evaporate into the environment (depending to a large extent on the amount of hygroscopic compounds they carry and their ability to retain or release water, as well as to maintain an equilibrium, as in the case of sugars), on the other hand, ants can carry bait attached to their bodies, and the droppings that ants may leave in the test boxes are difficult to quantify.

This is why, with limited testing means, it is perfectly possible to detect palatability by the number of ants that are simultaneously eating the bait, or that are arranged in that position, since from previous tests, carried out with a multitude of repetitions, this form of palatability evaluation is directly proportional to the total grams ingested. By observation and experimentation, it is not necessary to identify the ants that are eating at a given moment and whether it is these or others that return to the bait, since even if only a few ants are eating, by the mechanism of tropholaxy, the bait is transferred from one ant to another, generally from the most satiated to the least satiated ants.

| Formulation C.1.1 -not an object of the invention, control- | |
|---|---|
| Sucrose: | 20% |
| Glucose: | 20% |
| Fructose: | 10% |
| Water: | 50% |

Formulation P.1.1 -according to the invention-

| | |
|---|---|
| Sucrose: | 20% |
| Glucose: | 20% |
| Fructose: | 10% |
| Water: | 49.5% |
| Cycloserine | 0.5% |

Formulation P.1.2 -according to the invention-

| | |
|---|---|
| Sucrose: | 20% |
| Glucose: | 20% |
| Fructose: | 10% |
| Water: | 49.5% |
| Floxin B | 0.5% |

Formulation P.1.3 -according to the invention-

| | |
|---|---|
| Sucrose: | 20% |
| Glucose: | 20% |
| Fructose: | 10% |
| Water: | 49% |
| Cycloserine | 0.5% |
| Floxin B | 0.5% |

Results of Example 1 in Lasius niger, in terms of palatability.

Test 1A - Lassius niger

| | n = 10 ants | | | |
|---|---|---|---|---|
| | Palatability in terms of ants visiting the bait | | | |
| Minute | C.1.1 | P.1.1 | P.1.2 | P.1.3 |
| 0 | 1 | 0 | 0 | 0 |
| 5 | 0 | 2 | 0 | 4 |
| 10 | 1 | 3 | 2 | 3 |
| 15 | 2 | 2 | 3 | 3 |
| 20 | 0 | 1 | 4 | 5 |
| 25 | 3 | 2 | 1 | 2 |
| 30 | 1 | 4 | 6 | 6 |
| 35 | 1 | 5 | 2 | 2 |
| 40 | 0 | 1 | 4 | 5 |
| 45 | 0 | 3 | 6 | 1 |
| 50 | 0 | 2 | 1 | 3 |
| 55 | 1 | 0 | 0 | 2 |
| 60 | 0 | 0 | 0 | 2 |
| TOTAL SUM | 10 | 25 | 29 | 38 |

It is observed that in all three embodiments of the invention, palatability has increased by 250% to 380%, being maximum at equal concentration in P.1.3, indicative of a synergistic effect in the combination.

Results of Example 1 in Linepithema humile, in terms of palatability.

Test 1B - Linepithema humile

| | n = 10 ants | | | |
|---|---|---|---|---|
| | Palatability in terms of ants visiting the bait | | | |
| Minute | C.1.1 | P.1.1 | P.1.2 | P.1.3 |
| 0 | 0 | 0 | 1 | 1 |
| 5 | 1 | 1 | 1 | 1 |
| 10 | 0 | 0 | 3 | 1 |
| 15 | 0 | 4 | 1 | 2 |
| 20 | 1 | 2 | 0 | 0 |
| 25 | 2 | 2 | 1 | 2 |
| 30 | 0 | 3 | 2 | 1 |
| 35 | 3 | 1 | 3 | 5 |
| 40 | 2 | 1 | 0 | 2 |
| 45 | 0 | 2 | 0 | 3 |
| 50 | 0 | 1 | 0 | 1 |
| 55 | 0 | 0 | 2 | 2 |
| 60 | 0 | 0 | 1 | 1 |
| TOTAL SUM | 9 | 17 | 15 | 22 |

The trend of the results obtained with Lasius niger is repeated, although on this occasion the total number of ants disposed of.

On the other hand (results not shown), when serine is used instead of cycloserine in the bait, an increase in palatability is also observed, although somewhat lower, around 1.5-1.7 times compared to the control, and when serine, cycloserine and phloxine B, or serine and phloxine B are combined, this increase is 1.7-1-8 times compared to the control, with no appreciable differences between these last two combinations.

### EXAMPLE 2

A similar test was performed with Periplaneta america, Blattella germanica and Blatta orientialis cockroaches, as detailed below for the first species. In this case, it was possible to evaluate the amount of bait ingested per individual, with the formulas of this example corresponding to those of Example 1, but replacing the 20% fructose in all of them by 20% commercial hazelnut cream, so that we have the formulations C.2.1, P.2.1, P.2.2, P.2.3 with that change only.

Test 2A - Periplaneta america

n = 8 cockroaches
Palatability in terms of grams ingested

| Minute | C.2.1 | P.2.1 | P.2.2 | P.2.3 |
|---|---|---|---|---|
| 60 | 0.3 | 0.4 | 0.6 | 1.0 |
| 120 | 0.6 | 1.2 | 0.8 | 1.4 |
| 180 | 1.0 | 3.1 | 1.4 | 2.9 |
| 240 | 2.1 | 3.5 | 2.4 | 3.9 |

The effect is more pronounced in the cycloserine bait, and in the combination of cycloserine and phloxine B.

Likewise (results not shown), it is observed that serine also increases palatability, but to a lesser extent than cycloserine.

This is why a preferred embodiment of the invention is the one with the best results, i.e. with cycloserine and/or phloxine B.

It is remarkable that the effect of increased palatability occurs in different species, down to genus, subfamily, family, and even order, of the class Insecta. It is expected that this effect will be repeated in a generalised way, with the relevant exclusions, in the whole class Insecta (insects), being easy to test its effect from the ideas expressed in the present invention, simply by providing suitable baits adapted to each species and eliminating the species or other taxonomic level by simple trial and error tests without any inventive activity, at least referred to the testing of the palatability of serine, cycloserine and/or phloxine B.

Another aspect of the invention is the combination of serine, cycloserine and/or phloxine B with baits containing an insecticide. The fact that the insects consume more bait seems to favour that the amount of insecticide ingested also increases and therefore mortality of the target insect is achieved with lower concentration of insecticide.

The insecticides which can be combined with serine, cycloserine and/or phloxine B according to the present invention are described in the following paragraph, in their international characterisation in English, and according to classes defined by the organisation:
Insecticides: A0) various insecticides, including agrigata, al-phosphide, amblyseius, aphelinus, aphidius, aphidoletes, artimisinin, Autographa californica NPV, azocyclotin, Bacillus subtilis, Bacillus thuringiensis subsp. aizawai, Bacillus thuringiensis subsp. kurstaki, Bacillus thuringiensis, Beauveria, Beauveria bassiana, betacyfluthrin, biologicals, bisultap, brofluthrinate, bromophos-e, bromopropylate, Bt-Corn-GM, Bt-Soya-GM, capsaicin, cartap, celastrus-extract, chlorantraniliprole, chlorbenzuron, chlorethoxyfos, chlorfluazuron, chlorpyrifos-e, cnidiadin, cryolite, cyanophos, cyantraniliprole, cyclaniliprole, cyhalothrin, cyhexatin, cypermethrin, dacnusa, DCIP, dichloropropene, dicofol, diglyphus, diglyphus+dacnusa, dimethacarb, dithioether, dodecyl-acetate, emamectin, encarsia, EPN, eretmocerus, ethylene-dibromide, eucalyptol, fatty-acids, fatty-acids/salts, fenazaquin, fenobucarb (BPMC), fenpyroximate, flubrocythrinate, flufenzine, flupyradifurone, formetanate, formothion, furathiocarb, gamma-cyhalothrin, garlic-juice, granulosis-virus, harmonia, heliothis armigera NPV, inactive bacterium, indol-3-ylbutyric acid, iodomethane, iron, isocarbofos, isofenphos, isofenphos-m, isoprocarb, isothioate, kaolin, lindane, liuyangmycin, matrine, mephosfolan, metaldehyde, metarhizium-anisopliae, methamidophos, metolcarb (MTMC), mineral-oil, mirex, m-isothiocyanate, monosultap, myrothecium verrucaria, naled, neochrysocharis formosa, nicotine, nicotinoids, oil, oleic-acid, omethoate, orius, oxymatrine, paecilomyces, paraffin-oil, parathion-e, pasteuria, petroleum-oil, pheromones, phosphorus-acid, photorhabdus, phoxim, phytoseiulus, pirimiphos-e, plant-oil, Plutella xylostella GV, polyhedrosis-virus, polyphenol-extracts, potassium-oleate, profenofos, prosuler, prothiofos, pyraclofos, pyrethrins, pyridaphenthion, pyrimidifen, pyriproxifen, quillay-extract, quinomethionate, rape-oil, rotenone, saponin, saponozit, sodium-compounds, sodium-fluosilicate, starch, steinernema, streptomyces, sulfluramid, sulphur, tebupirimfos, temephos, tetradifon, tetraniliprole, thiofanox, thiometon, transgenics (e.g., Cry3Bb1), triazamate, trichoderma, trichogramma, triflumuron, verticillium, vertrine, isomeric insecticides (e.g., kappa-bifenthrin, kappa-tefluthrin), dichoromezotiaz, broflanilide, pyraziflumid; A1) the class of carbamates, including aldicarb, alanycarb, benfuracarb, carbaryl, carbofuran, carbosulfan, methiocarb, methomyl, oxamyl, pirimicarb, propoxur and thiodicarb; A2) the class of organophosphates, including acephate, azinphos-ethyl, azinphos-methyl, chlorfenvinphos, chlorpyrifos, chlorpyrifos-methyl, demeton-S-methyl, diazinon, dichlorvos/DDVP, dicrotophos, dimethoate, disulfoton, ethion, fenitrothion, fenthion, isoxathion, malathion, methamidaphos, methidathion, mevinphos, monocrotophos, oxymethoate, oxydemeton-methyl, parathion, parathion-methyl, phenthoate, phorate, phosalone, phosmet, phosphamidon, pirimiphos-methyl, quinalphos, terbufos, tetrachlorvinphos, triazophos and trichlorfon; A3) the class of cyclodiene organochlorine compounds such as endosulfan; A4) the class of fiproles, including ethiprole, fipronil, pyrafluprole and pyriprole; A5) the class of neonicotinoids, including acetamiprid, clothianidin, dinotefuran, imidacloprid, nitenpyram, thiacloprid and thiamethoxam; A6) the class of spinosyns such as spinosad and spinetoram; A7) chloride channel activators from the class of mectins, including abamectin, emamectin benzoate, ivermectin, lepimectin and milbemectin; A8) juvenile hormone mimics such as hydroprene, kinoprene, methoprene, fenoxycarb and pyriproxyfen; A9) selective homopteran feeding blockers such as pymetrozine, flonicamid and pyrifluquinazon; A10) mite growth inhibitors such as clofentezine, hexythiazox and etoxazole; A11) inhibitors of mitochondrial ATP synthase such as diafenthiuron, fenbutatin oxide and propargite; uncouplers of oxidative phosphorylation such as chlorfenapyr; A12) nicotinic acetylcholine receptor channel blockers such as bensultap, cartap hydrochloride, thiocyclam and thiosultap sodium; A13) inhibitors of the chitin biosynthesis type 0 from the benzoylurea class, including bistrifluron, diflubenzuron, flufenoxuron, hexaflumuron, lufenuron, novaluron and teflubenzuron; A14) inhibitors of the chitin biosynthesis type 1 such as buprofezin; A15) molting disruptors such as cyromazine; A16) ecdyson receptor agonists such as methoxyfenozide, tebufenozide, halofenozide and chromafenozide; A17) octopamin receptor agonists such as amitraz; A18) mitochondrial complex electron transport inhibitors pyridaben, tebufenpyrad, tolfenpyrad, flufenerim, cyenopyrafen, cyflumetofen, hydramethylnon, acequinocyl or fluacrypyrim; A19) voltage-dependent sodium channel blockers such as indoxacarb and metaflumizone; A20) inhibitors of the lipid synthesis such as spirodiclofen, spiromesifen and spirotetramat; A21) ryanodine receptor-modulators from the class of diamides, including flubendiamide, the phthalamide compounds (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, chlorantraniliprole, cyclaniliprole and cyantraniliprole; A22) compounds of unknown or uncertain mode of action such as azadirachtin, amidoflumet, bifenazate, fluensulfone, piperonyl butoxide, pyridalyl, sulfoxaflor; or A23) sodium channel modulators from the class of pyrethroids, including acrinathrin, allethrin, bifenthrin, cyfluthrin, lambda-cyhalothrin, cypermethrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen, tefluthrin and tralomethrin.

In particular, the preferred insecticides to be used in combination according to the present invention are of the class of pyrethrins, pyrethroids, neonicotinoids, avermectins and ivermectins, natural macrolides, fiproles. More particularly, mixtures with pyrethrins, 1R-trans-phenothrin, prallethrin, permethrin, alpha-cypermethrin, cypermethrin, beta-cypermethrin, zeta-cypermethrin are most preferred, allethrin, bioresmethrin, empenthrin, bifenthrin, lambda-cyhalothrin, cyhalothrin, supercyhalothrin, D-tetramethrin, tetramethrin, abamectin, ivermectin, spinosad, fipronil.

Surprisingly, it has been observed that the amount of active ingredient can be reduced up to 10-100 times and still maintain efficacy, i.e. the increased palatability not only favours higher bait uptake, but for some unknown reason, insects are also killed with smaller amounts of insecticide.

It should be noted that the tests carried out in the course of these investigations were performed in conditions of no natural light, and also in semi-darkness or complete darkness by covering the test boxes with black plastic in most cases. Therefore, we must rule out the possibility that what was observed in the present invention is due to the known phototoxicity of phloxin B. On the other hand, neither serine nor cycloserine has ever been described as an insecticide per se, at most it has been suggested that amino acids (cyclised or not), due to their effect on the activity of certain enzymes, affect for example blood-feeding mosquitoes. That is, it is ruled out that the effect on mortality is influenced by the use of amino acids.

### EXAMPLE 3

To test the combination effect of cycloserine and/or phloxine with known insecticides used in baits, we used an ant bait-type composition and its equivalents of Example 1, but containing 0.01 wt. % of the insecticide imidacloprid. Serine was also tested in parallel instead of cycloserine.

Composition of bait

| | C.3.1 | P.3.1 | P.3.2 | P.3.3 |
|---|---|---|---|---|
| Imidacloprid | 0.01 | 0.01 | 0.01 | 0.01 |
| Honey | 90.00 | 89.2 | 89.2 | 89.2 |
| Water | 9.99 | 9.99 | 9.99 | 9.99 |
| Cycloserine | 0.00 | 0.8 | 0 | 0.4 |
| Phloxine B | 0.00 | 0 | 0.8 | 0.4 |

The bait is offered to them, in boxes containing 10 Lasius niger ants each, for 3 hours, during which time palatability is observed.

| | n = 10 ants for 3 hours | | | |
|---|---|---|---|---|
| | Palatability in terms of ants visiting the bait | | | |
| | C.3.1 | P.3.1 | P.3.2 | P.3.3 |
| TOTAL SUM | 15 | 31 | 25 | 35 |

It is known that imidacloprid at the above-mentioned dose does not cause bait rejection, which is also observed here.

Considering that the ingestion is multiplied by at least a factor of 2, we get that each insect will die in approximately the same way with baits with increased palatability containing half or less of the insecticide.

Since baits usually have a rather short shelf life after opening (especially due to moisture loss which is also an attraction factor) (weeks or a few months) and the general practice is to oversize the amount of bait, by using the present invention the amount of insecticide per unit weight of bait could be reduced without having negative consequences on the efficacy.

### EXAMPLE 4

In this example we show different ant baits tested in boxes of 10 Linepithema humile individuals.

Composition of bait

| | C.3.1 | C.3.2 | P.3.1 | P.3.2 | P.3.3 | P.3.4 | P.3.5 | P.3.6 |
|---|---|---|---|---|---|---|---|---|
| 1R-trans- | 0.0100 | 0.0000 | 0.0100 | 0.0100 | 0.0100 | 0.0050 | 0.0010 | 0.0010 |
| Phenothrin | | | | | | | | |
| Prallethrin | 0.0010 | 0.0000 | 0.0010 | 0.0010 | 0.0010 | 0.0005 | 0.0001 | 0.0001 |
| Sugar mix | 89.0000 | 89.0000 | 89.0000 | 89.0000 | 89.0000 | 89.0000 | 89.0000 | 89.0000 |
| Emulsifier | 0.5000 | 0.5000 | 0.5000 | 0.5000 | 0.5000 | 0.5000 | 0.5000 | 0.5000 |
| mix | | | | | | | | |
| Natural gum | 0.5000 | 0.5000 | 0.5000 | 0.5000 | 0.5000 | 0.5000 | 0.5000 | 0.5000 |
| Water | 9.9890 | 10.0000 | 9.1890 | 9.1890 | 9.1890 | 9.1945 | 9.1989 | 9.1989 |
| Cycloserine | 0.0000 | 0.0000 | 0.8000 | 0.0000 | 0.4000 | 0.8000 | 0.8000 | 0.4000 |
| Phloxine B | 0.0000 | 0.0000 | 0.0000 | 0.8000 | 0.4000 | 0.0000 | 0.0000 | 0.4000 |
| | 100.0000 | 100.0000 | 100.0000 | 100.0000 | 100.0000 | 100.0000 | 100.0000 | 100.0000 |

The sugar mix is a mixture of sugars, such as for example invert glucose syrup with honey in a ratio of 10 to 1.

The emulsifier mix is a mixture of emulsifiers, such as for example C10-C14 ethoxylated alcohol, ethoxylated castor oil and Tween 80 or the like, in proportions, for example 1 to 1 to 1.

The natural gum can be e.g. gum arabic, xanthan gum, carrageenan, etc.

The cumulative mortality in 24 is complete (practically 100% in all cases, with natural test variability), even in those cases where the % in active ingredients has been divided by ten.

| | Mortality - Accumulated | | | | | | | |
|---|---|---|---|---|---|---|---|---|
| Hours | C.3.1 | C.3.2 | P.3.1 | P.3.2 | P.3.3 | P.3.4 | P.3.5 | P.3.6 |
| 0 | 0 | 0 | 0 | 0 | 0 | 0 | 0 | 0 |
| 0.5 | 1 | 0 | 2 | 1 | 2 | 2 | 1 | 0 |
| 1 | 2 | 0 | 2 | 3 | 3 | 2 | 3 | 2 |
| 4 | 3 | 0 | 4 | 4 | 4 | 3 | 3 | 2 |
| 8 | 3 | 0 | 4 | 5 | 5 | 5 | 4 | 4 |
| 12 | 4 | 0 | 5 | 5 | 6 | 5 | 6 | 5 |
| 24 | 9 | 0 | 10 | 10 | 10 | 9 | 10 | 10 |

Very similar results occur in tests both with cockroaches (Periplaneta americana, Blatta orientalis, Blattella germanica), with mosquitoes (Aedes aegypti, Aedes albopictus, Culex pipiens) and with flies (Musca domestica, Ceratitis capitata) which for brevity are not attached.

In the case of mosquito tests, the bait is given ad libitum to 50 specimens in 10 cm×10 cm×10 cm³ cloth cages, using cotton wool impregnated with the baits mentioned above, but with a sugar mix content of only 10%, the rest being compensated by adding more water to the formula, so that it is liquid enough to be absorbed by the mosquitoes.

Similarly, tests have been carried out with mosquitoes, but with house flies (Musca domestica) and with Mediterranean flies (Ceratitis capitata).

We thus have that both on different orders of insects (Diptera, Blattodea, Hymenoptera) the efficacy of the formulations according to the present invention is complete, both in terms of increased palatability of phloxine B, of cycloserine (either L-cycloserine, D-cycloserine or their mixtures in any ratio, including the racemic mixture since in more detailed trials we have not seen an activity of one isomer greater than the other), or of the combination of phloxine B and cycloserine.

Phloxin B is not described as an effective insecticide under dark or semi-dark conditions, as its well-known mechanism of action is by photo-oxidation, in particular under the action of sunlight. Cycloserine is also not described as an insecticide, at most it is known to interact with muscle metabolism in Aedes aegypti females (personal communication) when fed with blood.

On the other hand, in addition to the effect of increased palatability, the effect on mortality of compositions containing D-cycloserine, L-cycloserine and DL-cycloserine was investigated.

At this point, we encounter the unexpected situation, not observed in previous trials because it is not usual to determine death within a short time after exposure to the bait (e.g. from a few minutes to a maximum of 24 hours), that baits containing cycloserine exclusively as active ingredient (that is, in a conceptual simplification, water, sugar and cycloserine, or even water with cycloserine), both D-cycloserine and L-cycloserine or their mixtures in any ratio, present delayed mortality, reaching the elimination of the insects they have eaten in up to 7 days.

This circumstance, in addition to the use of cycloserine to increase the palatability of the baits, means that cycloserine can be used as an insecticide and also with an infrequent, or even unknown, particularity in pest control, i.e. the treated insects die in extraordinarily (relatively) long times of up to 7 days. This, which in principle may seem a disadvantage, is not so in certain cases, since it allows the ants to have more time to live functionally well, without external signs of intoxication that could warn other ants, and to transmit the bait by tropholaxy to the queen ant (or queen ants of the same anthill, when this is the case) and thus more effectively destroy the anthill. Similarly, the alertness (if any) of conspecifics to a dead cockroach near the bait is suppressed. In addition, cockroaches are known to be cannibalistic in the absence of alternative food, and we have found that the lethal effect of cycloserine on one cockroach is transferred to another cockroach if the latter is offered a cycloserine-treated cockroach (cannibalism occurs primarily on cockroaches that are turned over or otherwise affected). Similarly, for long-term pest control, immediacy is not an insurmountable requirement, so it is also applicable in mosquito control to prevent disease transmission or pest control in agriculture.

The experimental use in enzymology of L-cycloserine in the influence of blood protein metabolism and ammonia regulation and also with glucose supplementation, under laboratory rearing conditions with Aedes aegypti females, is known. However, no paper shows that cycloserine, both L and D, is able to induce death without the intervention of a protein diet or that it can be used as a medium- to long-term pest control mechanism. The enzymatic study of glutamic-pyruvic transaminase would not really explain the unexpected mortality in insects that have not been fed protein diet concomitantly with D- or L-cycloserine, or in the absence of it.

### EXAMPLE 5

Following the structure of the tests already set out in detail, an example of efficacy with different species can be shown here:

| | |
|---|---|
| Component | % in w/w |

Formulation A

| | |
|---|---|
| D-Cycloserine | 1 |
| Water | 89 |
| Sucrose | 10 |
| TOTAL | 100 |

Formulation B 2

| | |
|---|---|
| 1R-trans-Phenothrin | 0.01 |
| Honey | 90.00 |
| Water | 9.89 |
| Cycloserine | 0.10 |
| TOTAL | 100.00 |

Formulation C

| | |
|---|---|
| Cypermethrin | 0.1 |
| Sugar mix | 50 |
| Emulsifier mix | 0.3 |
| Natural gum | 0.3 |
| Water | 49.2 |
| Cycloserine | 0.05 |
| Phloxine B | 0.05 |
| TOTAL | 100 |

Following the above procedure, only using 10 individuals of each species (half females and half males, where appropriate), 100% mortality (after a 48-hour exposure period to ad libitum baits) is achieved for:

| | |
|---|---|
| Periplaneta americana: | 6 days |
| Aedes albopictus: | 5 days |
| Musca domestica: | 7 days |
| Ceratitis capitata | 8 days |
| Lasius niger | 7 days |

Control insects under the same conditions but with baits without cycloserine, phloxine B or insecticides and 100% compensated with water addition, and in no case exceeding 20% mortality.

According to our experience, the use of cycloserine as an insecticide seems to be, at least, of great efficacy in Lasius niger, Linepithema humile, Periplaneta americana, Blatta orientalis, Blattella germanica, Aedes aegyipti, Aedes albopictus, Culex pipiens, Culex quinquefasciatus, Anopheles gambiae, Musca domestica, Simuliidae ssp., Ceratitis capitata, Bactrocera oleae, Bactrocera cucurbitae.

Given the existing effect of cycloserine (in more detailed trials there was no significant difference in kill or duration with D-cycloserine, L-cycloserine or mixtures of both) on various genera and species, it is reasonable to assume that this novel insect control system is potentially effective in a wide range of genera or even families, i.e. it is per se a new type of insecticide with assured biodegradability, very low toxicity in humans and other mammals and easy to obtain industrially, especially in its racemic form.

The mechanism of action should be the subject of research in basic science as the reason for the aforementioned insecticidal efficacy is not known, particularly in insects with reduced muscular activity under test conditions and protein deprivation during the tests.

In short, the present invention describes:
1. A method for increasing the palatability of insecticidal baits characterised in that the baits contain, in addition to a known insecticide, at least one of these three compounds:
a. cycloserine (both D-cycloserine and L-cycloserine or any mixture of these)
b. serine (both D-serine and L-serine)
c. floxin B;
as well as compounds of the state of the art usual in baits.
2. A bait containing:
a. water
b. at least some sugar or source of sugar including honey
c. at least one insecticide at a concentration effective against the target pest selected
from insecticides which are part of the prior art
d. Phloxin and/or cycloserine and/or serine
e. Where required and/or desirable, emulsifiers, bittering agents such as denatonium benzoate, antioxidants such as BHT, colouring agents, antimicrobials, viscosity modifiers of natural polymeric type such as gum arabic or xanthan gum, or of synthetic or mineral type such as aluminosilicates.
3. A bait for killing crawling insects including cockroaches and ants characterised in that (percentage by weight):
a. water is between 10-99%
b. the insecticide of the state of the art is found in a sub-lethal amount below what is usual in baits that are proven to be effective at the commercial level.
c. phloxine is between 0.01-2%
d. serine is between 0.01-2%
e. cycloserine is between 0.01-2%
f. in the case of cockroaches, the presence of palatability enhancers such as vegetable product creams including peanut butter, as we have anecdotally observed that their presence leads to a higher number of visits to the baits, although apparently with a lesser influence than that caused by serine, cycloserine and/or phloxine B.
4. A method for killing insects using D-cycloserine, L-cycloserine or a mixture of both cycloserine isomers in any ratio.
5. The invention is not restricted to the following insects, but it has been on them that the invention has shown full efficacy measured in great detail: Lasius niger, Linepithema humile, Periplaneta americana, Blatta orientalis, Blattella germanica, Aedes aegyipti, Aedes albopictus, Culex pipiens, Culex quinquefasciatus, Anopheles gambiae, Musca domestica, Simuliidae ssp., Ceratitis capitata, Bactrocera oleae, Bactrocera cucurbitae.
6. The use of L-cycloserine as a mosquito insecticide except in artificially reared blood-fed Aedes aegypti females optionally supplemented with glucose and/or forcibly deprived of food for at least 24 hours before being treated with water, cycloserine, blood and/or glucose.

1. Product comprising at least one of the following compounds
a. cycloserine (both D-cycloserine and L-cycloserine or any mixture of these)
b. serine (both D-serine and L-serine) and cycloserine (both D-cycloserine and L-cycloserine or any mixture of these)
c. phloxine B;
d. serine (both D-serine and L-serine) and phloxine B
together with a known insecticide and compounds of the state of the art usual in baits, for use as an insecticide that increases palatability.

2. Bait according to claim 1, characterised in that said bait contains:
a. water
b. at least some sugar or source of sugar including honey
c. at least one insecticide at an effective concentration against the target pest selected from among:
i. A1-phosphide, amblyseius, aphelinus, aphidius, aphidoletes, artimisinin, Autographa californica NPV, azocyclotin, Bacillus subtilis, Bacillus thuringiensis subsp. aizawai, Bacillus thuringiensis subsp. kurstaki, Bacillus thuringiensis, Beauveria, Beauveria bassiana, betacyfluthrin, biologicals, bisultap, brofluthrinate, bromophos-e, bromopropylate, Bt-Corn-GM, Bt-Soya-GM, capsaicin, cartap, celastrus-extract, chlorantraniliprole, chlorbenzuron, chlorethoxyfos, chlorfluazuron, chlorpyrifos-e, cnidiadin, cryolite, cyanophos, cyantraniliprole, cyclaniliprole, cyhalothrin, cyhexatin, cypermethrin, dacnusa, DCIP, dichloropropene, dicofol, diglyphus, diglyphus+dacnusa, dimethacarb, dithioether, dodecyl-acetate, emamectin, encarsia, EPN, eretmocerus, ethylene-dibromide, eucalyptol, fatty-acids, fatty-acids/salts, fenazaquin, fenobucarb (BPMC), fenpyroximate, flubrocythrinate, flufenzine, flupyradifurone, formetanate, formothion, furathiocarb, gamma-cyhalothrin, garlic-juice, granulosis-virus, harmonia, heliothis armigera NPV, inactive bacterium, indol-3-ylbutyric acid, iodomethane, iron, isocarbofos, isofenphos, isofenphos-m, isoprocarb, isothioate, kaolin, lindane, liuyangmycin, matrine, mephosfolan, metaldehyde, metarhizium-anisopliae, methamidophos, metolcarb (MTMC), mineral-oil, mirex, m-isothiocyanate, monosultap, myrothecium verrucaria, naled, neochrysocharis formosa, nicotine, nicotinoids, oil, oleic-acid, omethoate, orius, oxymatrine, paecilomyces, paraffin-oil, parathion-e, pasteuria, petroleum-oil, pheromones, phosphorus-acid, photorhabdus, phoxim, phytoseiulus, pirimiphos-e, plant-oil, Plutella xylostella GV, polyhedrosis-virus, polyphenol-extracts, potassium-oleate, profenofos, prosuler, prothiofos, pyraclofos, pyrethrins, pyridaphenthion, pyrimidifen, pyriproxifen, quillay-extract, quinomethionate, rape-oil, rotenone, saponin, saponozit, sodium-compounds, sodium-fluosilicate, starch, steinernema, streptomyces, sulfluramid, sulphur, tebupirimfos, temephos, tetradifon, tetraniliprole, thiofanox, thiometon, transgenics, triazamate, trichoderma, trichogramma, triflumuron, verticillium, vertrine, kappa-bifenthrin, kappa-tefluthrin, dichoromezotiaz, broflanilide, pyraziflumid; aldicarb, alanycarb, benfuracarb, carbaryl, carbofuran, carbosulfan, methiocarb, methomyl, oxamyl, pirimicarb, propoxur and thiodicarb; acephate, azinphos-ethyl, azinphos-methyl, chlorfenvinphos, chlorpyrifos, chlorpyrifos-methyl, demeton-S-methyl, diazinon, dichlorvos, dicrotophos, dimethoate, disulfoton, ethion, fenitrothion, fenthion, isoxathion, malathion, methamidaphos, methidathion, mevinphos, monocrotophos, oxymethoate, oxydemeton-methyl, parathion, parathion-methyl, phenthoate, phorate, phosalone, phosmet, phosphamidon, pirimiphos-methyl, quinalphos, terbufos, tetrachlorvinphos, triazophos and trichlorfon; endosulfan; including ethiprole, fipronil, pyrafluprole and pyriprole; acetamiprid, clothianidin, dinotefuran, imidacloprid, nitenpyram, thiacloprid and thiamethoxam; spinosad, spinetoram; abamectin, emamectin benzoate, ivermectin, lepimectin and milbemectin; hydroprene, kinoprene, methoprene, fenoxycarb and pyriproxyfen; pymetrozine, flonicamid and pyrifluquinazon; clofentezine, hexythiazox and etoxazole; diafenthiuron, fenbutatin oxide and propargite; chlorfenapyr; bensultap, cartap hydrochloride, thiocyclam and thiosultap sodium; bistrifluron, diflubenzuron, flufenoxuron, hexaflumuron, lufenuron, novaluron and teflubenzuron; buprofezin; cyromazine; methoxyfenozide, tebufenozide, halofenozide and chromafenozide; amitraz; pyridaben, tebufenpyrad, tolfenpyrad, flufenerim, cyenopyrafen, cyflumetofen, hydramethylnon, acequinocyl or fluacrypyrim indoxacarb and metaflumizone; spirodiclofen, spiromesifen and spirotetramat; flubendiamide, the phthalamide compounds (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, chlorantraniliprole, cyclaniliprole and cyantraniliprole; azadirachtin, amidoflumet, bifenazate, fluensulfone, piperonyl butoxide, pyridalyl, sulfoxaflor; pyrethrins, pyrethroids including acrinathrin, allethrin, bifenthrin, cyfluthrin, lambda-cyhalothrin, cypermethrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen, tefluthrin and tralomethrin.
d. Phloxine and/or cycloserine and/or serine with cycloserine and/or serine with phloxine B
e. Where required and/or desirable, emulsifiers, bittering agents such as denatonium benzoate, antioxidants such as BHT, colouring agents, antimicrobials, viscosity modifiers of natural polymeric type such as Arabic gum or xanthan gum, or of synthetic or mineral type such as aluminosilicates.

3. A bait for killing crawling insects including cockroaches and ants characterised in that (percentage by weight):
a. water is between 10-99%
b. the insecticide of the state of the art is found in a sub-lethal amount below what is usual in baits that are proven to be effective at the commercial level.
c. phloxine is between 0.01-2%
d. serine is between 0.01-2%
e. cycloserine is between 0.01-2%
and in the case of cockroaches, the presence of palatability enhancers such as creams of vegetable products including peanut butter.

4. D-cycloserine, L-cycloserine or a mixture of both cycloserine isomers in any ratio for use as an insecticide except when L-cycloserine is used to kill blood and/or glucose-deprived Aedes aegypti females.

5. D-cycloserine, L-cycloserine or a mixture of both cycloserine isomers as an insecticide according to claim 4, characterised in that the target insects belong to one of the following group: Lasius niger, Linepithema humile, Periplaneta americana, Blatta orientalis, Blattella germanica, Aedes aegyipti, Aedes albopictus, Culex pipiens, Culex quinquefasciatus, Anopheles gambiae, Musca domestica, Simuliidae ssp., Ceratitis capitata, Bactrocera oleae, Bactrocera cucurbitae.

6. L-cycloserine for use as an insecticide to kill mosquitoes, except when L-cycloserine is applied to artificially reared blood-fed Aedes aegypti females optionally supplemented with glucose and optionally deprived of food for more than 24 hours.
